(19) United States
(12) Patent Application Publication
(10) Pub. No.: US 2024/0228088 A1
(43) Pub. Date: Jul. 11, 2024

(54) STRAPPING TOOL

(71) Applicants: Christian NOELKE, Duesseldorf (DE); Bastian PROTZMANN, Wuppertal (DE); Tianhao WU, Schwelm (DE)

(72) Inventors: Christian NOELKE, Duesseldorf (DE); Bastian PROTZMANN, Wuppertal (DE); Tianhao WU, Schwelm (DE)

(21) Appl. No.: 18/538,727

(22) Filed: Dec. 13, 2023

(30) Foreign Application Priority Data
Jan. 5, 2023 (EP) 23150386.3

(51) Int. Cl. B65B 13/02; B65B 13/32

(52) U.S. Cl. CPC B65B 13/025; B65B 13/322; B65B 13/327

(57) ABSTRACT

A strapping tool has a body, a motorized drive in or on the body, and a process sensor for recording at least process data of the drive. A receiver is provided for wireless remote transfer of the process data.

### FIELD OF THE INVENTION

The present invention relates to a strapping apparatus. More particularly this invention concerns a manual strapping tool.

### BACKGROUND OF THE INVENTION

A manual strapping tool typically has at least one body, a preferably motorized drive in or on the body, and a process sensor connected to the drive for recording process data. Such a tool is normally used, for instance, to wrap and fix together steel strapping around metal strap coils in order to secure the metal strap coils in question. Alternatively, strapping tools can also be used to wrap plastic strapping around bales of paper or cloth, for example, and to secure the bale of cloth or paper after welding together its ends. Both stationary strapping tools and mobile manual strapping tools, which are operated by an operator, are used.

The tool ensures that the strapping is tensioned and the ends of the steel or plastic strap to be joined are juxtaposed. This can be done by crimping in the case of steel strapping, for example, or by friction welding in the case of plastic strapping. In the former case, the body is equipped with a crimping die that is moved with the aid of the drive and performs the necessary crimping. In the case of a friction-welded joint, the drive ensures a frictional back and forth movement of friction surfaces on the overlapping ends of the plastic strapping to be joined.

The crimping die and friction surfaces of the body described above must be serviced at regular intervals in order to fulfill its intended function and to ensure that the ends of the strips are closed properly. This is necessary for safety reasons alone. For this reason, state-of-the-art strapping tools have been equipped with a kind of counter in order to obtain information about processing cycles. This is described in CN 204068576, among others. There, a permanent magnet is provided on a drive shaft of a drive motor inside the body. As soon as the drive motor rotates, counting pulses can be generated and the number of motor revolutions can be determined.

CN 208806716 takes a similar approach. In this case too, the rotation of a drive motor inside the body is detected. Another sensor is assigned to the drive for this purpose.

U.S. Pat. No. 6,911,799 describes a combination of a strapping machine and a control system for a welding motor. The control system has a proximity sensor. The sensor can be used to detect rotation of the motor operatively connected to a welding member. In this way, a signal can be generated to control the motor.

Finally, U.S. Pat. No. 4,811,368 deals generally with a sensor using a wheel that can be used for speed measurement in conjunction with electric drive motors.

The state of the art has basically proven itself, but there is still room for improvement. For example, the detection of counting signals from a drive motor on the body requires an operator to monitor the counting signals and take or initiate any maintenance measures as a result. To do this, the operator must have additional knowledge, for example, about the number of cycles of the drive motor after which maintenance is required or recommended. This typically requires knowledge of the relevant information in manuals, which is not always immediately available or accessible. For this reason, necessary maintenance intervals are often overlooked, resulting in avoidable operational failures. This is where the invention aims to provide a remedy.

### OBJECTS OF THE INVENTION

It is therefore an object of the present invention to provide an improved strapping apparatus.

Another object is the provision of such an improved strapping apparatus that overcomes the above-given disadvantages, in particular that continuous functionality is guaranteed.

### SUMMARY OF THE INVENTION

To attain this object, a strapping tool of the type according to the invention is characterized in that the process sensor is wirelessly connected to a receiver in order to transfer process data.

The process data recorded and transmitted by the process sensor typically includes operating data such as the number of cycles of welding the ends of the strap, the temperature of any motorized drive present, the electrical current consumed by the drive under certain circumstances, the charge status of the optionally installed battery, the pneumatic pressure in the case of a pneumatic drive, etc.

In order to be able to distinguish the process data of different strapping tools from one another, these additionally contain a machine identifier so that the exact strapping tool can be identified. If the optional motorized drive is not actuated electrically or pneumatically but, for example, chemically and corresponding consumables have to be supplied to the strapping tool according to the invention or the motorized drive, the process data naturally also generally reflect such consumption data.

Alternatively or additionally, the process data can also reflect consumption data for the strapping used. Among other things, this consumption data then provides information about the strap consumption of the strapping tool in question. With the aid of an additional and optionally provided display, some or all of this determined process data can be displayed directly on the strapping tool. It is understood that, depending on the process data to be considered, not only a process sensor assigned to the drive can be provided, but also additional process sensors can be in or on the strapping tool and specifically on the body. Either way, comprehensive process data of the strapping tool according to the invention is available, which is wirelessly transmitted to the associated remote receiver

The receiver can be located in the immediate vicinity or far away from the strapping tool. Here, for example, ranges of from several to up to 10 km and more are possible on large company premises. Such wireless remote transmission, taking into account the specified range, can be realized and implemented particularly advantageously in the radio frequency range.

In fact, the invention typically operates in the subgigahertz range of, for example, 800 MHZ to 950 MHZ, which is generally used by radio frequencies and can therefore be used free of charge. In other words, by using this radio-frequency range, there are typically no telecommunication charges between the strapping tool according to the invention and the receiver.

This represents a major advantage over internet-enabled devices in connection with the realization of an ioT (Internet of things) architecture, which not only requires an associated SIM card in the device in question, but also the payment of monthly fees if data transmission is to take place according to the LTE standard, for example.

Since the strapping tool according to the invention is generally equipped with a single-use or rechargeable battery, it is furthermore and advantageously provided that the wireless remote transmission of the process data to the receiver takes place as a function of signals from an actuation sensor. This actuation sensor is provided in addition to the one or more process sensors. The actuation sensor is in turn connected to a controller with a transmitter, which is woken up by its signals and returns to a sleep mode after a predetermined period of time. This optimally protects the battery or the rechargeable battery installed at this point from unnecessary discharging.

In addition, this procedure ensures that power is only actually consumed in accordance with the invention when the actuation sensor transmits its actuation to the controller. This typically occurs when the strapping tool or its body is used for a strapping process or for welding strap ends. Outside of these operating times, the controller is in idle mode together with the transmitter. The same applies to the drive. This means that no unnecessary electrical energy is consumed.

This results in a further advantage over devices equipped with a SIM card, for example, because in this case signals are constantly exchanged between the transmitter and the receiver, which ultimately confirm the existence of the LTE connection implemented here as an example. Such constant data exchange is expressly dispensed with in accordance with the invention. This is because this data transfer only takes place when the controller is awakened by an actuation of the strapping tool and thus of the actuation sensor. This is followed by wireless remote transmission of the process data to the receiver. As soon as a predetermined period of time has elapsed, for example 30 seconds or 1 minute, the controller returns to sleep mode together with the transmitter. The same applies to any drive.

It is understood that the transmitter of the controller and the receiver are tuned to each other, namely, according to an advantageous embodiment, are set up for wireless remote transmission in the radio frequency range and in particular in the subgigahertz range.

The wireless remote transmission in the radio frequency range in question is carried out using a modulation process. In this way, the process data can be transmitted directly and in the form of binary data and, if necessary, further processed by the receiver.

In fact, wireless long-distance transmission is advantageously based on wobble frequency pulses. In this context, each wobbled frequency pulse may correspond to a spread of 5 to 12, for example. The number of bits to be transmitted can then be specified based on the spreading factor. In this context and, as is generally the case, the spreading factor defines the ratio of the number of individually spread single channels for a user channel. Typically, the so-called LoRa standard (Long Range Area) is used at this point, which provides a transmission rate of 0.3 Kbit/s to 50 Kbit/s per channel, for example. In principle, rates of 1 Mbit/s and more can also be realized.

According to a further advantageous embodiment, the receiver that receives the process data transmitted by the transmitter of the strapping tool, is equipped with a memory for the process data. In addition, it has proven to be advantageous in this context if the receiver, including the memory, is designed as part of a network, for example the Internet. The process data recorded by the receiver can therefore be transmitted to an evaluation unit via the network. The evaluation unit can then use the process data to determine whether, for example, maintenance is required and, if so, when. The evaluation unit can also be used to determine whether, for example, it is advisable to replace the strapping tool or carry out a general overhaul. In addition, statements can be made about the consumption of strapping as well as, for example, the loads on the optional drive.

The process data is generally transmitted wirelessly and/or via wires via the network. The process data is typically available as network protocols and can, for example, be transmitted according to the TCP (Transmission Control Protocol) or the UTP (User Datagram Protocol). These are connection-oriented and packet-switching network protocols that are regularly used for end-to-end connection between two network participants, namely the receiver and the evaluation unit, for transporting the process data.

In addition to the process sensor and the actuation sensor, the strapping tool or the associated body can also be equipped with a GPS sensor (Global Positioning System). In this way, it is possible to locate the body in question, for example on a large company site. For this purpose, several receivers for the process data transmitted by the transmitter of the strapping tool are typically distributed across the premises in question. The exact position of the strapping tool or body in question can now be determined by triangulation for example as is generally known for position determination.

In this way, the process data evaluated by the evaluation unit and the data from the GPS sensor can be used not only to determine whether and which strapping tool requires maintenance. In addition, this maintenance information can also be provided with a position specification for the strapping tool in question so that, for example, maintenance personnel can immediately find the strapping tool in question and carry out the previously defined, targeted maintenance.

For this purpose, the evaluation unit can, for example, set up a maintenance log for the relevant strapping tool with the necessary location information and transmit it to the operator of the strapping tool. Depending on the urgency of the maintenance, for example, the maintenance log can of course also be accompanied by an alarm message if required. For this purpose, the evaluation unit is advantageously provided, for example, by the manufacturer of the strapping tool or the manufacturer has access to it and can thus inform the user or his customers accordingly.

According to the invention, all of this is particularly simple, intuitive and accurate. This is because any maintenance is monitored using process data that is generated by the strapping tool and transmitted to the receiver or the evaluation unit. As a result, maintenance intervals, any revisions etc. can be carried out precisely and adapted to actual requirements.

In addition, it is possible not only to identify the strapping tool concerned in terms of its maintenance requirements, but also to determine its current location and transmit it to maintenance personnel, for example. This saves costs and ensures that the strapping tool is always functional. This strapping tool can basically be a stationary device that is used, for example, to wrap steel strapping or plastic strapping around large-volume goods and secure them by connecting the strap ends to be joined using the body. In general, however, the strapping tool can also be designed as a manual strapping tool. In this case, the manual strapping tool is manipulated by an operator and is also connected to an air pressurizing unit for pneumatic operation, for example. In principle, an electric drive and a cordless battery supply can also be used here. This is where the main advantages can be seen.

### BRIEF DESCRIPTION OF THE DRAWING

The above and other objects, features, and advantages will become more readily apparent from the following description, reference being made to the accompanying drawing in which:

FIG. 1 is a partially schematic side view of a portable strapping apparatus according to the invention;

FIG. 2 schematically shows the FIG. 1 system in a wireless network; and

FIG. 3 is a graph of the wobbled wireless signal used here.

### SPECIFIC DESCRIPTION OF THE INVENTION

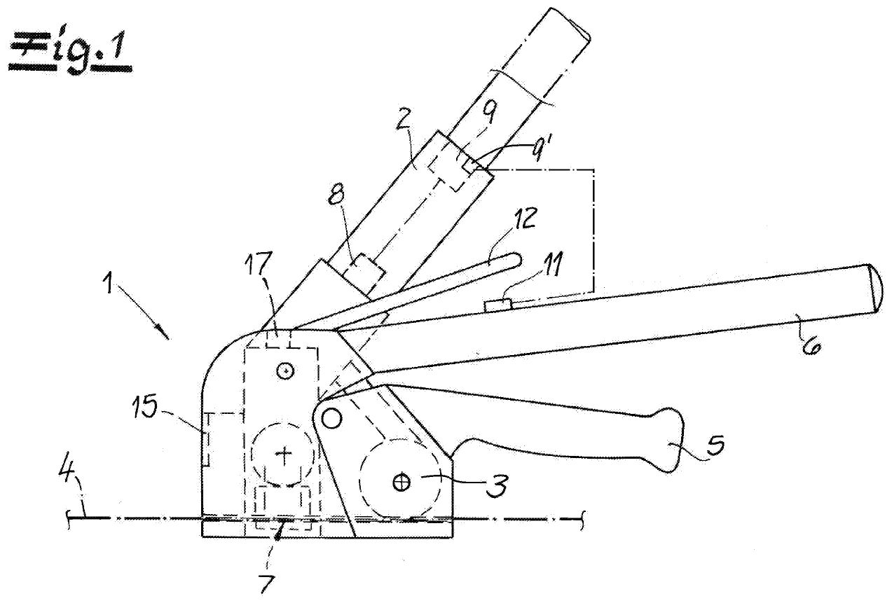

The drawing shows a manual strapping tool having a body 1. In addition, according to the illustrated embodiment, there is a motor drive 2 that is powered pneumatically according to FIG. 1, but can also be powered electrically just as well, in which case the associated electrical energy is supplied by a battery in the housing of the body 1, which is not illustrated. The battery may be rechargeable in this case. For this purpose, the battery can be removed from the housing and replaced. However, it is also possible that the battery is permanently installed in the housing and the housing is equipped with a socket for charging the battery.

According to this embodiment, the drive 2 is used to drive an illustrated tensioning wheel 3 that is used to position and tension a strap 4 shown schematically in FIG. 1 around the goods to be strapped. In addition, an actuating lever 5 is provided in conjunction with an arm 6 fixedly extending from the body 1. This allows an operator to operate the body 1 by grasping the pivotal lever 5 and the arm 6 with the right hand.

In contrast, the left hand is free to insert the overlapping strap ends of the strap 4 into a slot-shaped seat 7 of the housing of the body 1. After inserting the overlapping strap ends of the strap 4 into the slot-shaped seat 7 of the housing of the body 1, the lever 5 is released so that the tension wheel 3 provides the required tension. Once the desired strap tension of the strap 4 has been reached, according to the illustrated embodiment and not restrictively, a weldless closure of the strap ends can be introduced by actuating the arm 6.

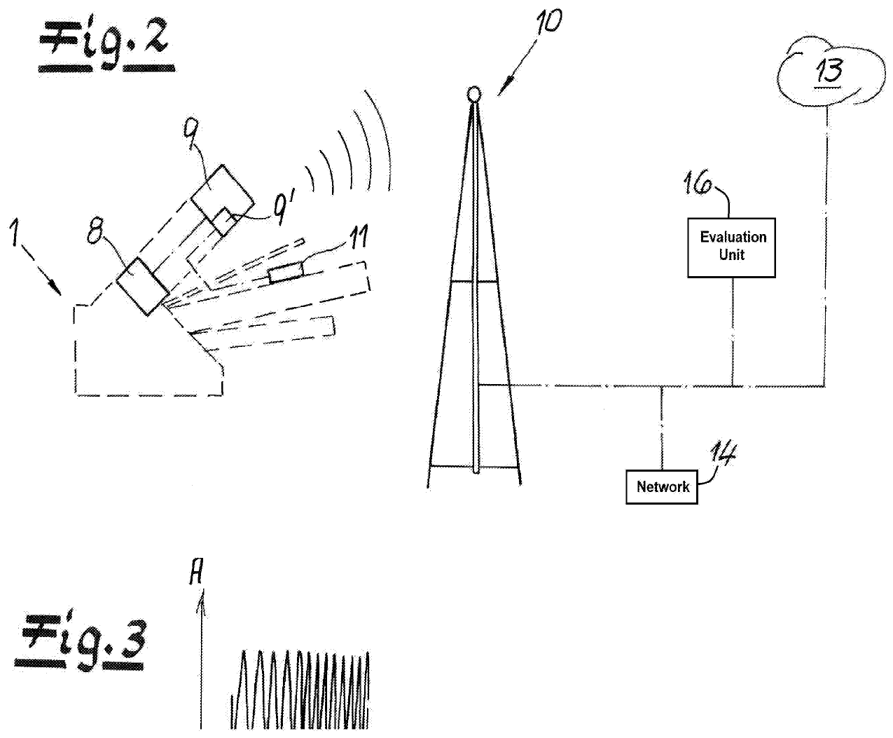

In fact, the actuation of the arm 6 corresponds to the fact that two tools not explicitly shown are pressed against each other and ensure the already mentioned weldless closure of the overlapping strap ends of the strap 4. According to the illustrated embodiment, a process sensor 8, which is indicated in FIG. 1 and referred to and explained in more detail in FIGS. 2 and 3, is assigned to the basically dispensable motorized drive 2 in or on the body 1 as part of the illustrated embodiment. The process sensor 8 is connected to a controller 9 with an integrated or additional transmitter 9′. The controller 9 can be provided in or on the housing of the body 1 and is supplied electrically with the aid of the battery, which is not explicitly shown.

FIG. 2 now shows that the transmitter 9′ belonging to the controller 9 can be used to transmit process data generated by the strapping tool to a receiver 10 by means of wireless remote transmission. The process data is provided by the process sensor 8. For this purpose, the process sensor 8 may count the revolutions of the motorized drive 2, which is not shown in detail, in the context of the illustrated embodiment and not restrictively. This allows conclusions to be drawn about a respective actuation of the body 1 and an associated strapping cycle.

In principle, the controller 9 including transmitter 9′ can also be used to transmit other process data to the receiver 10 in the sense of the wireless remote transmission indicated in FIG. 2, for example the operating data of the body 1 explained above to the description as well as consumption data of strap 4.

The wireless remote transmission from the transmitter 9′ to the receiver 10 takes place as a function of signals from an actuation sensor 11. According to the illustrated embodiment, this actuation sensor 11 is assigned to another pivotal lever 12 on the motorized drive 2, with the aid of which the motorized drive 2 is set in motion. As soon as the motorized drive 2 is running in order to tension the strap 4, a signal from the actuation sensor 11, which is connected to the controller 9, corresponds to this.

As a result, the wireless remote transmission between the transmitter 9′ and the receiver 10 can take place depending on signals from the relevant actuation sensor 11. In this way, the controller 9 is awakened in accordance with signals from the actuation sensor 11. As soon as signals from the actuation sensor 11 are no longer registered by the controller 9, for example because the lever 12 for the drive 2 is released, a timer assigned to the controller 9 generally ensures that a certain period of time, for example half a minute, 1 minute or several minutes, elapses. If the lever 12, and therefore the actuation sensor 11, is not actuated again within this period of time, the controller 9, and with it the transmitter 9′, goes into sleep mode.

This sleep mode is maintained until the controller 9, and with it the transmitter 9′, is awakened by a renewed actuation of the lever 12 and thus of the actuation sensor 11. In this way, the overall electrical energy consumption of the strapping tool according to the invention is reduced to a minimum. This is because no wireless remote transmission takes place between the transmitter 9′ and the receiver 10 during sleep mode. The wireless remote transmission is carried out in the radio frequency range in accordance with the explanations in the introductory description. Here, the so-called subgigahertz range has proven to be particularly favorable. In addition, wireless radio transmission is carried out using a modulation method. In fact, wobbled frequency pulses are transmitted at this point, as shown schematically in FIG. 3.

Here you can see such a single wobbled frequency pulse, which operates with the same amplitude A throughout in accordance with the spread band technology. Only the frequency f changes within a fixed time T between an initial frequency f₁ and a final frequency f₂.

In this way, the process data can be transmitted digitally to the receiver 10. The LoRa standard and so-called CSS modulation (Chirp Spread Spectrum) are advantageously used here. This allows maximum transmission rates of up to 2 Mbit/s to be transmitted at ranges of up to several kilometers outdoors. Each wobbled frequency pulse shown in FIG. 3 may correspond to a spreading factor of 5 to 12, for example, which also specifies the number of transmitted bits.

FIG. 2 shows that the receiver 10 is also equipped with a memory 13. The memory 13 may be a so-called “cloud”, i.e. a memory on the Internet. This is because the receiver 10, like the memory 13 according to the illustrated embodiment, is a component of an associated network 14, according to the illustrated embodiment, the Internet. The process data transmitted from the body 1 or its transmitter 9′ to the receiver 10 is now in turn transmitted wirelessly and/or by wire via the network 14 in question. For this purpose, the process data is available in the network as network protocols, as already described in detail above.

The process data is typically operating data such as the number of cycles completed by the body 1, the temperature of the motorized drive 2, the pressure of the pneumatic medium according to the illustrated embodiment for operating the motorized drive 2, etc. In addition, a machine identifier must usually be included as part of the process data in order to be able to precisely identify the body 1 or the associated strapping tool. In addition, the process data typically also includes consumption data such as how much strapping has been consumed.

The above-described process data can be display directly on the body 1 by a display 15 on the front of the housing of the body 1. In addition, according to the illustrated embodiment, an evaluation unit 16 is also provided that is connected to the network 14 and processes the process data stored in the memory 13. The evaluation unit 16 may be located in the area of or accessible to the manufacturer of the strapping tool in question.

In this way, the manufacturer can use the process data evaluated with the aid of the evaluation unit 16 to decide whether, for example, strap 4 needs to be resupplied, whether maintenance is required, whether the motor 2 needs to be switched off due to overheating, and so on. All of this information can be transmitted from the evaluation unit 16 to an operator of the strapping tool, for example to a cell phone or other receiver carried by the operator. It is conceivable here that the operator receives a corresponding message on his cell phone, for example in the form of an SMS. In this way, the operator can either initiate maintenance measures himself or ensure that strapping 4 is reordered, or inform the evaluation unit 16 that external maintenance is required. Of course, remote maintenance of the strapping tool in question can also be carried out using the outlined method with the help of the evaluation unit 16. Thus, for example, the transmitter 9′ also has a receiver 10. The transmitter 9′ can also be also designed as a receiver.

In order to enable precise maintenance in this context, for example when operating various manual strapping tools on an extensive area, the body 1 is also equipped with a GPS sensor 17 inside the housing of the body 1. The signals from the GPS sensor 17 can be transmitted to the receiver 10 together with the process data from the transmitter 9′. If several receivers 10 are present on the site already mentioned, the exact position of each of the bodies 1 can be determined precisely using triangulation, for example. This may include GPS coordinates that are transmitted to the evaluation unit 16 together with the process data. This allows maintenance personnel, for example, to be informed precisely of the location of the strapping tool in question.

1. A strapping tool comprising:
a body;
a motorized drive in or on the body;
a process sensor for recording at least process data of the drive; and
a receiver for remote wireless transfer of the process data.

2. The tool according to claim 1, further comprising:
an actuation sensor outputting signals to the receiver.

3. The tool according to claim 2, further comprising:
a controller connected to the actuation sensor for outputting signals; and
a transmitter in the controller, that is awakened in accordance with signals from the controller, and that returns to a sleep mode after a predetermined period of time.

4. The tool according to claim 1, wherein the wireless remote transmission takes place in a subgigahertz radio frequency range.

5. The tool according to claim 1, wherein the wireless remote transmission is carried out according to a modulation method.

6. The tool according to claim 1, wherein the wireless remote transmission takes place on the basis of wobbled frequency pulses.

7. The tool according to claim 6, wherein each wobbled frequency pulse corresponds to a spreading factor of 5 to 12.

8. The tool according to claim 7, wherein the spreading factor defines the number of transmitted bits.

9. The tool according to claim 1, further comprising:
a memory in the receiver for the process data.

10. The tool according to claim 9, wherein the receiver and the memory are formed as components of a network.

11. The tool according to claim 10, wherein the process data are transmitted wirelessly and/or by wired in the network.

12. The tool according to claim 10, wherein the process data are present in the network as network protocols.

13. The tool according to claim 1, wherein the process data includes cycle number, temperature, pressure, or a machine identifier.

14. The tool according to claim 1, wherein the process data includes data regarding consumption of the strap.

15. The tool according to o claim 1, further comprising:
a display on the body for the process data.
